(19) United States
(12) Patent Application Publication
(10) Pub. No.: US 2007/0174200 A1
(43) Pub. Date: Jul. 26, 2007

(54) Medium purchase and playback protection system and its method

(75) Inventors: Pae Sung-Min, Chung Ho City (TW); Park Hyun Chul, Chung Ho City (TW)

Correspondence Address: TROXELL LAW OFFICE PLLC;ONE SKYLINE PLACE, SUITE 1404, 5205 LEESBURG PIKE, FALLS CHURCH, VA, 22041, US

(73) Assignee: POWER QUOTIENT INTERNATIONAL CO., LTD.

(21) Appl. No.: 11/449,603

(22) Filed: Jun. 9, 2006

(30) Foreign Application Priority Data
Jan. 26, 2006 (TW) 095103053

(51) Int. Cl. G06Q 99/00

(52) U.S. Cl. 705/52

(57) ABSTRACT

The present invention relates to a medium purchase and playback protection medium method, comprising the steps of: a user of a portable electronic device buying a storage device from a supplier, wherein the portable electronic device includes a set of first identification codes, and the storage device includes a set of second identification codes, and the storage device includes a swappable medium, and the medium including a set of third identification codes; the supplier delivering the storage device and the medium to the user; the user connecting the storage device to the portable electronic device; and the portable electronic device checking whether the first identification codes, the second identification codes, the third identification codes, and the fourth identification codes are matched or not; if yes, then the portable electronic device can read the medium in the storage device and delete the content of the medium after reading the content of the medium; if not, then the portable electronic device can not read the medium in the storage device. Furthermore, the present invention also provides a medium purchase and playback protection system.

### BACKGROUND OF THE INVENTION

1. Field of the Invention

The present invention relates to a medium purchase and playback protection system, and more particularly to a portable electronic device which will check whether the identification code of a medium inserted therein and its own identification code are matched or not; if yes, then the portable electronic device can read the medium and delete the content of the medium after reading the content of the medium; if not, then the portable electronic device can not read the medium in the device.

2. Description of the Related Art

In general, audio and video files can be downloaded from a server and played in a DVD, VCD, Blu-ray, HD DVD, VCD, Blu-ray, HD DVD or CD player by means of a simple security check according to a prior art. However, the security check may be skipped by users, and thus DVD, VCD, Blu-ray, HD DVD, VCD, Blu-ray, HD DVD or CD publishers cannot request users to pay for the downloaded files and thus the unauthorized use of DVD, VCD, Blu-ray, HD DVD, VCD, Blu-ray, HD DVD or CD media becomes more and more.

Furthermore, at present, user can not get an identification code from the supplier when he/she buys computer software(s), DVD, VCD, Blu-ray, HD DVD, VCD, Blu-ray, HD DVD or CD through network; therefore, the supplier can not effectively stop the user from illegally copying the computer software(s), DVD, VCD, Blu-ray, HD DVD, VCD, Blu-ray, HD DVD or CD, such that the benefit of the supplier will be harmed. Furthermore, the computer software(s), DVD, VCD, Blu-ray, HD DVD, VCD, Blu-ray, HD DVD or CD does not have the read-once function, therefore, its sale price remains higher, thus user will be less willing to buy the legal computer software(s), DVD, VCD, Blu-ray, HD DVD, VCD, Blu-ray, HD DVD or CD.

At present, there are systems or solutions that can solve the problem of protecting DVD, VCD, Blu-ray, HD DVD or CD from unauthorized copying. For example, U.S. Pat. No. 5,991,403 issued to Aucsmith, et al disclosed a method for encoding MPEG compatible video data for subsequent compression that comprises detecting a plurality of frames of video data organized as a GOP, generating an encryption key for the GOP, and encrypting the video data using GOP-synchronized substitution, transposition, and rotation transformations that are parameterized by offsets derived from the generated encryption key.

U.S. Pat. No. 5,915,018 issued to Aucsmith, et al disclosed a cryptographic system and method for secure distribution and management of cryptographic keys for use in a DVD copy protection scheme. A DVD disc having compressed, encrypted content written on a first portion of the disc, and the content encryption key, itself encrypted with a second key and written out of band on a second portion of the disc is used to provide content, key, and control information to a DVD player.

The U.S. Pat. No. 5,991,403 disclosed a method for encoding MPEG compatible video data for subsequent compression; while the U.S. Pat. No. 5,915,018 disclosed a cryptographic system and method for secure distribution and management of cryptographic keys for use in a DVD copy protection scheme. However, the prior arts could not provide a system or method used for a portable electronic device, for example but not limited to a portable media play device with a display device, such as a LCD for legally playing computer software(s), audio file(s) or video file(s) in the CD, DVD. Furthermore, the computer software(s), DVD, VCD, Blu-ray, HD DVD or CD does not have the read-once function, therefore, the sale price of the CDs or DVDs could not be reduced.

### SUMMARY OF THE INVENTION

Therefore, it is a primary objective of the present invention to overcome the foregoing shortcomings of the prior art by providing a system and method for medium purchase and playback protection, which will check whether the identification code of a medium inserted into a portable electronic device and the portable electronic device's identification code are matched or not; if yes, then the portable electronic device can read the medium and delete the content of the medium after reading the content of the medium; if not, then the portable electronic device can not read the medium in the device.

Another objective of the present invention is to overcome the foregoing shortcomings of the prior art by providing a system and method for medium purchase and playback protection, which provides a read-once medium for reducing the sale price of the DVD, VCD, Blu-ray, HD DVD or CD.

Another objective of the present invention is to overcome the foregoing shortcomings of the prior art by providing a system and method for medium purchase and playback protection, which will read the medium and delete the content of the medium after reading the medium, so as to resolve the problem of computer software(s), DVD, VCD, Blu-ray, HD DVD or CD illegally copying.

To achieve the foregoing objectives, a system for medium purchase and playback protection in accordance with the present invention comprises: a portable electronic device, comprising a display device, a port, and a set of first identification codes; and a storage device, supplied by a supplier, comprising a set of second identification codes and the storage device including a swappable medium, and the swapping medium including a set of third identification codes; thereby the portable electronic device will check whether the first identification codes, the second identification codes and the third identification codes are matched or not when the user connects the storage device to the portable electronic device; if yes, then the portable electronic device can read the medium in the storage device and delete the content of the medium after reading the content of the medium; if not, then the portable electronic device can not read the medium in the storage device.

To achieve the foregoing objectives, a medium purchase and playback protection method in accordance with the present invention comprising the steps of: a user of a portable electronic device buying a storage device from a supplier, wherein the portable electronic device includes a set of first identification codes, and the storage device includes a set of second identification codes, and the storage device includes a swappable medium, and the medium including a set of third identification codes; the supplier delivering the storage device and the medium to the user; the user connecting the storage device to the portable electronic device; and the portable electronic device checking whether the first identification codes, the second identification codes and the third identification codes are matched or not; if yes, then the portable electronic device can read the medium in the storage device and delete the content of the medium after reading the content of the medium; if not, then the portable electronic device can not read the medium in the storage device.

### BRIEF DESCRIPTION OF THE DRAWINGS

FIG. 1 is a block diagram of a system for medium purchase and playback protection according to a preferred embodiment of the invention.

FIG. 2 is a flowchart of a method for medium purchase and playback protection according to a preferred embodiment of the invention.

### DETAILED DESCRIPTION OF THE PREFERRED EMBODIMENTS

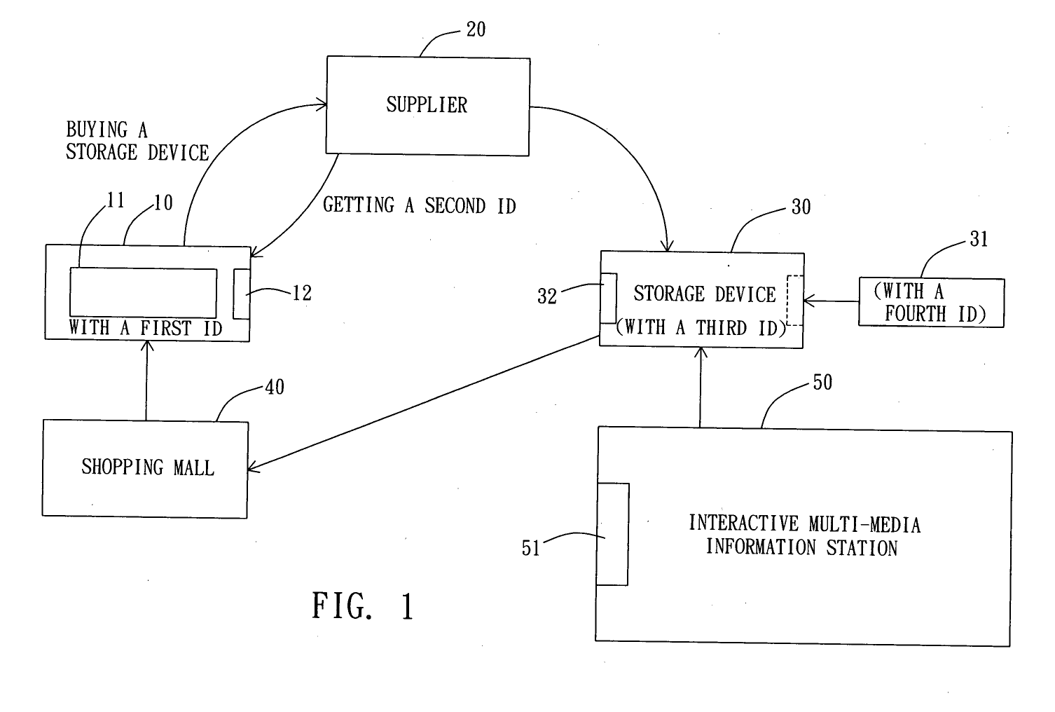

Referring to FIG. 1, which shows a block diagram of a system for medium purchase and playback protection according to a preferred embodiment of the invention; as shown in the FIG, the system for medium purchase and playback protection of the present invention comprises: a portable electronic device 10 and a storage device 30.

Wherein, the portable electronic device 10 at lease comprises a CPU (not shown), a display device 11, a connecting port 12 and a set of first identification codes (ID), and the first identification codes are unique codes, for example but not limited to a producing serial number of the portable electronic device 10 or CPU, wherein the portable electronic device 10 is for example but not limited to a portable media play device which can play the content(s) of the CD or DVD. The connecting port 12 is for example but not limited to a USB port, IEEE 1394 port, SATA port, IDE port or port with other interface; for the purpose of explaining, the description of the present invention uses the USB port as an example of the connecting port 12 and it does not be used to limit the scope of the present invention.

The storage device 30 is supplied by a supplier 20, and the storage device 30 includes a set of second identification codes and a swappable medium 31, and the swapping medium 31 includes a set of third identification codes; wherein, the storage device 30 is for example but not limited to a CD player, a VCD player, a DVD player/recorder, HD DVD player/recorder, Blu-ray player, HD DVD player/recorder or a USB card reader, or a USB flash memory device, and the medium 31 is a hard disk (such as a 3.5″, 2.5″, 1.8″, 1″ or 0.8″ hard disk), an optical storage medium (such as a CD, DVD, Blu-ray, HD DVD or VCD), and the optical storage medium 31 includes an authorized read-once computer program, CD music, DVD, Blu-ray, HD DVD movie, or VCD movie. The memory card is for example but not limited to a Compact Flash, Microdrive, mini SD, MMC, Security Digital, RSMMC Memory Stick, Memory Stick Pro, XD, Memory Stick Duo, or memory Stick Pro Duo memory card. The supplier 20 records the third identification codes along with the computer program, CD music, DVD movie, or VCD movie ordered by the user into the medium 31 when the supplier 20 receives the order mailed from the user. Furthermore,

Furthermore, for increasing the security, the supplier 20 further provides a set of fourth identification codes to the user when the storage device 30 is sold to the user, and the second identification codes, the third identification codes and the fourth identification codes are unique codes, too.

Furthermore, the storage device 30 further comprises a connecting port 32, for example but not limited to a USB port, an IEEE 1394 port, a SATA port, an IDE port or port with other interface for connecting with the connecting port 12; for the purpose of explaining, the description of the present invention uses the USB port as an example of the connecting port 32 and it does not be used to limit the scope of the present invention.

While operating, a user of the portable electronic device 10 could buy the storage device 20 from a supplier 20 through an internet network or a telephone network (both not shown), wherein the portable electronic device 10 includes a set of first identification codes, and the storage device 30 includes a set of second identification codes, and the storage device 30 includes a swappable medium 31, and the medium 31 includes a set of third identification codes and adding the fourth identification codes obtains from the supplier 20; the supplier 20 records the computer program, CD music, DVD movie, or VCD movie ordered by the user into the medium 31 when the supplier 20 receives the order mailed from the user; the supplier 20 delivers the storage device 30 and the medium 31 to the user or a shopping mall 40 or hypermarket (such as Carrefour, 7-11 convenience store, etc.) near user's home by Fedex or UPS; then user can get the storage device 30 and the medium 31 from the shopping mall 40 or hypermarket; and then the portable electronic device 10 will check the first identification codes, the second identification codes, the third identification codes and the fourth identification codes are matched or not; if yes, then the portable electronic device 10 can read the medium 31 in the storage device 30 and delete the content of the medium 31 after reading the content of the medium 31; if not, then the portable electronic device 10 can not read the medium 31 in the storage device 30. Wherein, the portable electronic device 10 will further send out a control signal to the storage device 30 to erase the content of the medium 31, after the portable electronic device 10 reads the medium 31. Therefore, the portable electronic device 10 of the abovementioned system can execute or play the authorized read-once computer software(s), audio file(s) or video file(s) in the CD, DVD and delete the content of the medium 31 after reading the content of the medium 31; therefore, the benefit of the publisher of the computer software(s), audio file(s) or video file(s) can be ensured and the sale price of the CDs or DVDs could be reduced.

When the medium 31 is a memory card, the user can use the deleted (or blank) medium 31 as a general storage device or send it back to the supplier 20 for storing the new content therein when the user orders a new content.

Furthermore, the medium purchase and playback protection system of the present invention further comprises an interactive multi-media information station 50 (such as a Kiosk), which comprises a slot(not shown) or a connecting port 51 for providing connecting with the storage device 30 through an internet or telephone network; the supplier 20 can exhibit various read-once computer software(s), audio file(s) or video file(s) in the CD, DVD, such that the user can directly buy the computer software(s), audio file(s) or video file(s) from the interactive multi-media information station 50 and the interactive multi-media information station 50 will download the computer software(s), audio file(s) or video file(s) to the medium 31; then user can insert the medium 31 into the storage device 30 and connect it to the portable electronic device 10; and then the portable electronic device 10 will check the first identification codes, the second identification codes, the third identification codes and the fourth identification codes are matched; if yes, then the portable electronic device 10 can read the medium 31 in the storage device 30 and delete the content of the medium 31 after reading the content of the medium 31; if not, then the portable electronic device 10 can not read the medium 31 in the storage device 30. Therefore, the medium purchase and playback protection system of the present invention can reduce the purchase time to the user and also can reduce the delivery time.

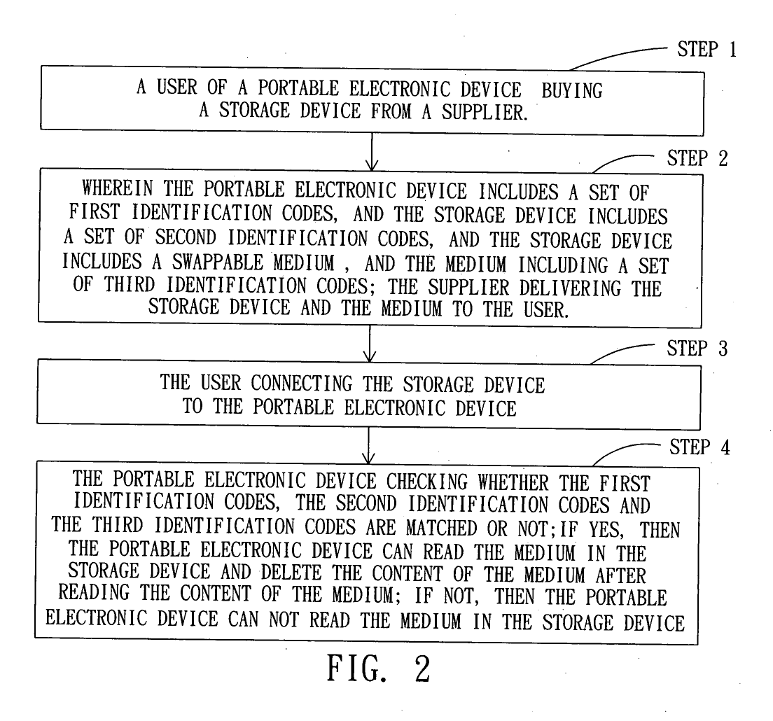

Referring to FIG. 2, it shows a flow chart of a medium purchase and playback protection method according to one preferred embodiment of the invention. As shown in the FIG., the medium purchase and playback protection method of the present invention comprises the steps of: a user of a portable electronic device 10 buying a storage device 30 from a supplier 20 (step 1), wherein the portable electronic device 10 includes a set of first identification codes, and the storage device 30 includes a set of second identification codes, and the storage device 30 includes a swappable medium 31, and the medium 31 including a set of third identification codes; the supplier 20 delivering the storage device 30 and the medium 31 to the user (step 2); the user connecting the storage device 30 to the portable electronic device 10 (step 3); and the portable electronic device 10 checking whether the first identification codes, the second identification codes and the third identification codes are matched or not; if yes, then the portable electronic device can read the medium in the storage device and delete the content of the medium after reading the content of the medium; if not, then the portable electronic device can not read the medium in the storage device(step 4).

In step 1, the portable electronic device 10 at lease comprises a CPU (not shown), a display device 11, a connecting port 12 and a set of first identification codes (ID), and the first identification codes are unique codes, for example but not limited to a producing serial number of the portable electronic device 10 or CPU, wherein the portable electronic device 10 is for example but not limited to a portable media play device which can play and display the content(s) of the CD, DVD, Blu-ray, HD DVD or VCD.

The storage device 30 is supplied by a supplier 20, and the storage device 30 includes a set of second identification codes and a swappable medium 31, and the swapping medium 31 includes a set of third identification codes; wherein, the storage device 30 is for example but not limited to a CD player, a VCD player, a DVD player/recorder, HD DVD player/recorder, Blu-ray player, HD DVD player/recorder or a USB card reader, or a USB flash memory device, and the medium 31 is a hard disk (such as a 3.5″, 2.5″, 1.8″, 1″ or 0.8″ hard disk), an optical storage medium (such as a CD, DVD, Blu-ray, HD DVD or VCD), and the optical storage medium 31 includes an authorized read-once computer program, CD music, DVD, Blu-ray, HD DVD movie, or VCD movie. The memory card is for example but not limited to a Compact Flash, Microdrive, mini SD, MMC, Security Digital, RSMMC Memory Stick, Memory Stick Pro, XD, Memory Stick Duo, or memory Stick Pro Duo memory card. The supplier 20 records the third identification codes along with the computer program, CD music, DVD movie, or VCD movie ordered by the user into the medium 31 when the supplier 20 receives the order mailed from the user.

Furthermore, for increasing the security, the supplier 20 further provides a set of fourth identification codes to the user when the storage device 30 is sold to the user in the step 1, and the first identification codes, the second identification codes, the third identification codes and the fourth identification codes are unique codes, too.

In step 2, the supplier 20 entrusts a courier to send the storage device 30 and the medium 31 to the user, for example but not limited to Fedex or UPS, or the supplier 20 mails the storage device 30 and the medium 31 to a shopping mall 40 or hypermarket (such as Carrefour, 7-11 convenience store, etc.) near user's home by Fedex or UPS; then user can get the storage device 30 and the medium 31 from the shopping mall 40 or hypermarket.

In steps 3˜4, the user can connect the storage device 30 to the portable electronic device 10 when he/she gets the storage device 30 and the medium 31 from the shopping mall 40 or hypermarket; and then the portable electronic device 10 will check the first identification codes, the second identification codes, the third identification codes and the fourth identification codes are matched; if yes, then the portable electronic device 10 can read the medium 31 in the storage device 30 and the portable electronic device 10 can play and display the content of the medium 31 and then delete the content of the medium 31 after reading the content of the medium 31; if any one of the identification codes is not matched, then the portable electronic device 10 can not read the medium 31 in the storage device 30. Wherein, the portable electronic device 10 will send out a control signal to the storage device 30 to erase the content of the medium 31, after the portable electronic device 10 reads the medium 31. Therefore, the portable electronic device 10 of the abovementioned method can execute or play the authorized read-once computer software(s), audio file(s) or video file(s) in the CD, DVD, Blu-ray, HD DVD or VCD and delete the content of the medium 31 after reading the content of the medium 31; therefore, the benefit of the publisher of the computer software(s), audio file(s) or video file(s) can be ensured and the sale price of the CD, DVD, Blu-ray, HD DVD or VCD could be reduced so as to overcome the shortcomings of the prior art.

When the medium 31 is a memory card, the user can use the deleted (or blank) medium 31 as a general storage device or send it back to the supplier 20 for storing the new content therein when the user orders a new content.

Furthermore, the medium purchase and playback protection method of the present invention further comprises a step of: the user paying a deposit to the supplier 20 while making the purchase, and then delivering the medium 31 to the supplier 20 after use, and the supplier 20 returning the deposit to the user when the storage device 30 is a card reader with USB interface or a flash memory device with USB interface (step 5).

Furthermore, the medium purchase and playback protection method of the present invention further comprises step of: providing a interactive multi-media information station 50 for selling the medium 31 (step 6); wherein, the interactive multi-media information station 50 also comprises a connecting port 51 for providing connecting with the portable electronic device 10; the supplier 20 can exhibit various read-once computer software(s), audio file(s) or video file(s) in the CD, DVD, such that the user can directly buy the computer software(s), audio file(s) or video file(s) from the interactive multi-media information station 50 and the interactive multi-media information station 50 will download the computer software(s), audio file(s) or video file(s) to the medium 31; then user can insert the medium 31 into the storage device 30 and connect it to the portable electronic device 10; and then the portable electronic device 10 will check the first identification codes, the second identification codes, the third identification codes and the fourth identification codes are matched; if yes, then the portable electronic device 10 can read the medium 31 in the storage device 30 and delete the content of the medium 31 after reading the content of the medium 31; if not, then the portable electronic device 10 can not read the medium 31 in the storage device 30. Therefore, the medium purchase and playback protection system of the present invention can reduce the purchase time to the user and also can reduce the delivery time.

With the implementation of the present invention, the portable electronic device 10 will check the identification codes are matched; if yes, then the portable electronic device 10 can read the medium 31 in the storage device 30 and delete the content of the medium 31 after reading the content of the medium 31; if not, then the portable electronic device 10 can not read the medium 31 in the storage device 30; therefore, the medium purchase and playback protection system and method of the present invention can overcome the shortcomings of the prior arts.

While the invention has been described by way of example and in terms of a preferred embodiment, it is to be understood that the invention is not limited thereto. To the contrary, it is intended to cover various modifications and similar arrangements and procedures, and the scope of the appended claims therefore should be accorded the broadest interpretation so as to encompass all such modifications and similar arrangements and procedures.

In summation of the above description, the present invention herein enhances the performance than the conventional structure and further complies with the patent application requirements and is submitted to the Patent and Trademark Office for review and granting of the commensurate patent rights.

What is claimed is:

1. A medium purchase and playback protection system, comprising:
a portable electronic device, comprising a display device, a port, and a set of first identification codes; and
a storage device, supplied by a supplier, comprising a set of second identification codes and said storage device including a swappable medium, and said swapping medium including a set of third identification codes;
thereby said portable electronic device will check whether said first identification codes said second identification codes and said third identification codes are matched or not when said user connects said storage device to said portable electronic device; if yes, then said portable electronic device can read said medium in said storage device and delete the content of said medium after reading the content of said medium; if not, then said portable electronic device can not read said medium in said storage device.

2. The medium purchase and playback protection system of claim 1, wherein said portable electronic device is a portable audio/video playback device.

3. The medium purchase and playback protection system of claim 1, wherein said supplier further provides a set of fourth identification codes when said user buys said storage device from said supplier.

4. The medium purchase and playback protection system of claim 3, wherein said portable electronic device will check whether said first identification codes, said second identification codes, said third identification codes and said fourth identification codes are matched or not; if yes, then said portable electronic device can read said medium in said storage device and delete the content of said medium after reading the content of said medium; if not, then said portable electronic device can not read said medium in said storage device.

5. The medium purchase and playback protection system of claim 1, wherein said storage device is a CD player, a VCD player, a DVD player/recorder, HD DVD player/recorder, Blu-ray player, HD DVD player/recorder or a USB card reader, or a USB flash memory device.

6. The medium purchase and playback protection system of claim 1, wherein said medium is a 3.5″, 2.5″, 1.8″, 1.0″ or 0.8″ Hard Disk.

7. The medium purchase and playback protection system of claim 1, wherein said medium is an optical storage medium, it could be a CD, DVD, Blu-ray, HD DVD or VCD, and said optical storage medium includes an authorized read-once computer program, CD music, DVD, Blu-ray, HD DVD movie, or VCD movie.

8. The medium purchase and playback protection system of claim 1, wherein said medium is a memory card, it could be a Compact Flash, Microdrive, mini SD, MMC, Security Digital, RSMMC Memory Stick, Memory Stick Pro, XD, Memory Stick Duo, or memory Stick Pro Duo memory card.

9. The medium purchase and playback protection system of claim 1, it further comprises an interactive multi-media information station, which comprises a slot or a connection port and can be connected to said supplier through an internet or telephone network, and the user can connect said portable electronic device to said interactive multi-media information station through said connection port or plugs said memory card into said slot for downloading computer program, CD music, DVD, Blu-ray, HD DVD movie, or VCD movie.

10. The medium purchase and playback protection system of claim 3, wherein said first identification codes, said second identification codes, said third identification codes, and said fourth identification codes are unique codes.

11. The medium purchase and playback protection system of claim 1, wherein said port is a USB port, an IEEE1394 port, a SATA port, an IDE port or a port with other interface.

12. The medium put-chase and playback protection system of claim 1, wherein said portable electronic device sends out a control signal to said storage device to erase the content of said storage device, after said portable electronic device reads said medium.

13. A medium purchase and playback protection method, comprising the steps of:
a user of a portable electronic device buying a storage device from a supplier, wherein said portable electronic device includes a set of first identification codes,
and said storage device includes a set of second identification codes, and said storage device includes a swappable medium, and said medium including a set of third identification codes;
said supplier delivering said storage device and said medium to said user;
said user connecting said storage device to said portable electronic device; and
said portable electronic device checking whether said first identification codes, said second identification codes, said third identification codes, and said fourth identification codes are matched or not; if yes, then said portable electronic device can read said medium in said storage device and delete the content of said medium after reading the content of said medium; if not, then said portable electronic device can not read said medium in said storage device.

14. The medium purchase and playback protection method of claim 13, wherein said portable electronic device is a portable audio/video playback device.

15. The medium purchase and playback protection method of claim 13, wherein said supplier further provides a set of fourth identification codes when said user buys said storage device from said supplier.

16. The medium purchase and playback protection method of claim 15, wherein said wherein said portable electronic device will check whether said first identification codes, said second identification codes, said third identification codes and said fourth identification codes are matched or not; if yes, then said portable electronic device can read said medium in said storage device and delete the content of said medium after reading the content of said medium; if not, then said portable electronic device can not read said medium in said storage device.

17. The medium purchase and playback protection method of claim 13, wherein said storage device is a CD player, a VCD player, a DVD player/recorder, HD DVD player/recorder; Blu-ray player, HD DVD player/recorder or a USB card reader, or a USB flash memory device.

18. The medium purchase and playback protection method of claim 13, wherein said medium is a Hard Disk, an optical storage medium or a memory card.

19. The medium purchase and playback protection method of claim 18, wherein said optical storage medium is a CD, DVD, Blu-ray, HD DVD or VCD, and said optical storage medium includes an authorized read-once computer program, CD music, DVD, Blu-ray, HD DVD movie, or VCD movie.

20. The medium purchase and playback protection method of claim 18, wherein said memory card is a Compact Flash, Microdrive, mini SD, MMC, Security Digital, RSMMC Memory Stick, Memory Stick Pro, XD, Memory Stick Duo, or memory Stick Pro Duo memory card.

21. The medium purchase and playback protection method of claim 17, wherein if said storage device is a USB card reader or a USB flash memory storage device, the step of said user of said portable electronic device buying a storage device from a supplier further comprises a step of said user paying a deposit to said supplier while making the purchase, and then delivering said medium to said supplier after use, and said supplier returning said deposit to said user.

22. The medium purchase and playback protection method of claim 13, wherein said supplier entrusts a courier to send said storage device and said medium to said user, in the step of said supplier sending said storage device and said medium to said user.

23. The medium purchase and playback protection method of claim 13, wherein said supplier entrusts a courier to send said storage device and said medium to a shopping mall and said user picks up the merchandises from said shopping mall, in the step of said supplier sending said storage device and said medium to said user.

24. The medium purchase and playback protection method of claim 13, it further comprises a step of providing an interactive multi-media information station, which comprises a slot or a connection port and can be connected to said supplier through an internet or telephone network, and the user can connect said portable electronic device to said interactive multi-media information station through said connection port or plugs said memory card into said slot for downloading computer program, CD music, DVD, Blu-ray, HD DVD movie, or VCD movie.

25. The medium purchase and playback protection method of claim 13, wherein said first identification codes, said second identification codes, said third identification codes, and said fourth identification codes are unique codes.

26. The medium purchase and playback protection method of claim 13, wherein said port is a USB port, an IEEE1394 port, a SATA port, an IDE port or a port with other interface.

27. The medium purchase and playback protection method of claim 13, wherein said portable electronic device sends out a control signal to said storage device to erase the content of said storage device, after said portable electronic device reads said medium.
